(19) United States
(12) Patent Application Publication
(10) Pub. No.: US 2012/0243090 A1
(43) Pub. Date: Sep. 27, 2012

(54) LIGHT TRANSPARENT DISPLAY AND AN IMAGE DISPLAY DEVICE

(75) Inventors: Masataka NAKASHIMA, Shinjuku-Ku (JP); Norinaga NAKAMURA, Shinjuku-Ku (JP)

(73) Assignee: Dai Nippon Printing Co., Ltd., Shinjuku-Ku (JP)

(21) Appl. No.: 13/491,929

(22) Filed: Jun. 8, 2012

Related U.S. Application Data
(62) Division of application No. 12/823,625, filed on Jun. 25, 2010.
Application No. 12/823,625 is a division of application No. 11/570,681, filed on Dec. 15, 2006, now abandoned.

(30) Foreign Application Priority Data
Jun. 15, 2004 (JP) 2004-177388

(51) Int. Cl. G02B 5/30

(52) U.S. Cl. 359/488.01

(57) ABSTRACT

An antistatic laminate is provided that simplifies the production of a polarizing plate and, at the same time, can satisfactorily meets requirements of IPS and VA modes. The antistatic laminate is adapted for use in polarizing plates and comprises a light transparent base material and an antistatic layer provided on the light transparent base material. The antistatic layer is located between the polarizing element of the polarizing plate and a light transparent display site while using a polarizing plate.

### CROSS REFERENCE TO RELATED APPLICATIONS

This application is a division of U.S. patent application Ser. No. 12/823,625, filed Jun. 25, 2010, which in turn is a division of U.S. patent application Ser. No. 11/570,681 filed Dec. 15, 2006, now abandoned, which was the National Stage of International Application No. PCT/JP2005/010945 filed Jun. 15, 2005, and claims the priority of Japanese Patent Application No. 2004-177388 filed Jun. 15, 2004, the entireties of which are incorporated herein by reference.

### FIELD OF THE INVENTION

The present invention relates to an antistatic laminate for use, for example, in displays, particularly liquid crystal displays, CRTs, and plasma display panels, and a polarizing plate using the same.

### BACKGROUND OF THE INVENTION

Displays using a polarizing plate commonly have a construction comprising a light transparent display site held between two polarizing plates, for example, a first polarizing plate and a second polarizing plate. Further, from the viewpoints of preventing discharge-derived discomfort, suppressing dust adsorption, and improving visibility, it is common practice to dispose an antistatic layer on the upper side of a polarizing element in the first polarizing plate on the image display side of the display. Japanese Patent Laid-Open No. 316504/2001 proposes a polarizing plate comprising an antistatic laminate disposed on the outermost surface side of the first polarizing plate (on the upper side of the polarizing element) on the image display side.

The provision of the antistatic laminate above the polarizing element in the first polarizing plate on the image display side can certainly develop the antistatic function with the highest efficiency. In fact, however, the antistatic laminate does not generally have satisfactory strength for disposition on the outermost surface of the display. Therefore, in order to improve the layer strength of the conventional antistatic laminate, it has been regarded that other layer such as a hardcoat layer or an anti-dazzling layer should be additionally coated. The construction of such other layers can impart layer strength and various optical characteristics as a protective film for a polarizing plate. In this case, however, a production step of stacking many layers should be provided. Accordingly, this complicates the production process, and, further, extreme care should be taken in coating for multilayer construction. Consequently, a lot of time is necessary for the production, and, at the same time, the production cost is increased.

For the above reason, there is an urgent need to provide an inexpensive antistatic laminate and a polarizing plate using the same by minimizing the necessary number of layers provided on a sheet of light transparent base material to simplify the production process.

### SUMMARY OF THE INVENTION

At the time of the present invention, the present inventors have found that, when an antistatic laminate is not disposed on the upper side of a polarizing element in the first polarizing plate as viewed from the image display side, the following advantages can be attained. Specifically, multilayer coating in a protective film for a polarizing element can be simplified, and a polarizing plate can be produced in a short time and easily. As a result, it was found that the production cost can be reduced and, at the same time, the same antistatic effect as the case where the antistatic laminate is disposed on the outermost surface of the display, can be imparted. The present invention has been made based on such finding, and an object of the present invention is to provide an antistatic laminate, which can facilitate the production of a polarizing plate and can satisfactorily exhibit the function of the antistatic laminate per se, and a polarizing plate using the same.

### First Aspect of the Present Invention

According to the present invention, there is provided an antistatic laminate for use in a polarizing plate, the antistatic laminate comprising a light transparent base material and an antistatic layer provided on the light transparent base material, the antistatic layer is located beneath or below a polarizing element in the polarizing plate as viewed from an image display side, when the antistatic laminate is used in the polarizing plate.

In another embodiment of the present invention, there is provided a polarizing plate comprising an antistatic laminate. In the polarizing plate, the antistatic laminate comprises a light transparent base material and an antistatic layer provided on the light transparent base material, and the antistatic layer is located beneath or below a polarizing element in the polarizing plate as viewed from an image display side.

In a further embodiment of the present invention, there is provided a light transparent display comprising a light transparent display site held between a first polarizing plate and a second polarizing plate. In the light transparent display, the first polarizing plate is provided on the light transparent display site in its image display side and is a polarizing plate according to the present invention, and the second polarizing plate is provided on the light transparent display site on its non-image display side and does not include any antistatic laminate.

The first aspect of the present invention is advantageous in that the formation of the antistatic layer on the lower part of the polarizing element in the first polarizing plate can realize an antistatic laminate, in which the number of other layers in an optical laminate has been reduced, and, thus, can simplify the production of a polarizing plate.

### Second Aspect of the Present Invention

According to a second aspect of the present invention, there is provided a light transparent display comprising a light transparent display site held between a first polarizing plate and a second polarizing plate. In the light transparent display, the first polarizing plate is provided on the light transparent display site in its image display side and does not include any antistatic laminate, and the second polarizing plate is provided on the light transparent display site in its non-image display side and is a polarizing plate according to the first aspect of the present invention.

In another embodiment of the present invention, there is provided a light transparent display comprising a light transparent display site held between a first polarizing plate and a second polarizing plate. In the light transparent display, the first polarizing plate is provided on the light transparent display site in its image display side and does not include any antistatic laminate, the second polarizing plate comprises an antistatic laminate and a polarizing element, and the antistatic laminate and the polarizing element are provided in that order, or alternatively the polarizing element and the antistatic laminate are provided in that order.

In an optical laminate which can satisfactorily meet requirements of IPS (in-plane switching) and VA (domain vertical alignment) modes in LCDs, the provision of an antistatic layer in the production process of a liquid crystal display is indispensable for providing distortion-free beautiful images. Accordingly, according to the present invention, the presence of an antistatic laminate, which can be produced stably and simply, is important and indispensable.

### BRIEF DESCRIPTION OF THE DRAWINGS

FIG. 1 is a cross-sectional view of an antistatic laminate according to the present invention.

FIG. 2 is a cross-sectional view of a polarizing plate and a light transparent display according to the present invention.

FIG. 3 is a cross-sectional view of a polarizing plate and a light transparent display according to the present invention.

FIG. 4 is a cross-sectional view of a polarizing plate and a light transparent display according to the present invention.

### DETAILED DESCRIPTION OF THE INVENTION

### First Aspect of the Present Invention

The antistatic laminate according to the first aspect of the present invention is characterized by being not provided on or above (on the outermost side of) a polarizing element in a first polarizing plate but provided beneath or below a polarizing element in the polarizing plate.

Antistatic Laminate (Dust Adherence Preventive Laminate)

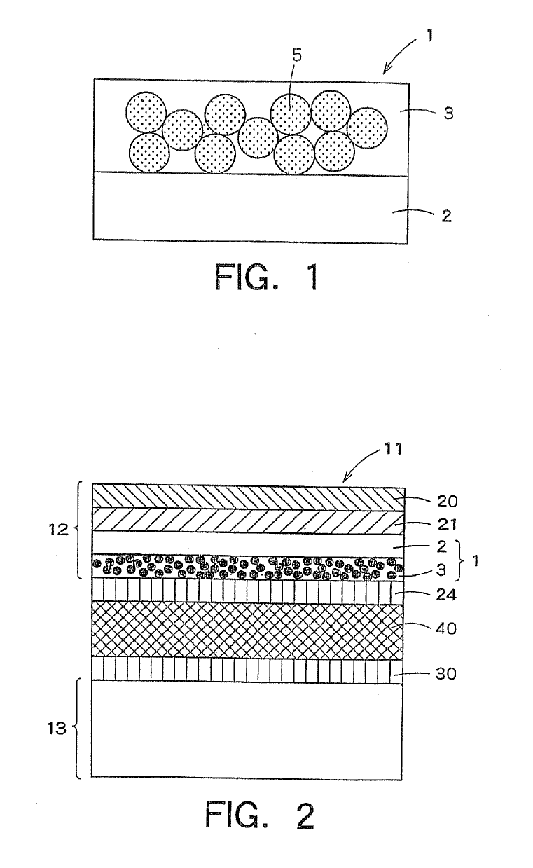

One embodiment of the antistatic laminate (dust adherence preventive laminate) used in a polarizing plate according to the present invention will be explained with reference to FIG. 1. FIG. 1 is a cross-sectional view of an antistatic laminate 1 according to the present invention. An antistatic layer 3 formed of a curing resin and an antistatic agent (fine particles) 5 is provided on the upper surface of a light transparent base material 2. When the antistatic laminate 1 is used in a polarizing plate, the antistatic layer 3 in the antistatic laminate 1 is not located on the outermost side of the first polarizing plate, that is, is not located on or above on the outermost side of the polarizing element.

Polarizing Plate Using Antistatic Laminate

The antistatic laminate (dust adherence preventive laminate) 1 according to the present invention has a simple layer construction as described above. The feature of the antistatic laminate is exhibited by use in a polarizing plate. Accordingly, the antistatic laminate will be explained with reference to FIG. 2 showing one embodiment of a light transparent display 11 according to the present invention. FIG. 2 is a cross-sectional view of the light transparent display 11 according to the present invention. The light transparent display 11 according to the present invention has a construction comprising a light transparent display site 40 held between a first polarizing plate 12 and a second polarizing plate 13, preferably between pressure-sensitive adhesives (layers) 24 and 30.

The first polarizing plate 12 in one embodiment of the present invention is provided on the upper surface of the light transparent display site 40 as viewed from the image display side. In the first polarizing plate 12, a polarizing element (layer) 21 is further provided on the antistatic laminate 1 (comprising an antistatic layer 3 and a light transparent base material 2) according to the present invention. In the present invention, the polarizing element (layer) 21 may be in contact with either the antistatic layer 3 or a light transparent base material 2 in the antistatic laminate 1. Preferably, as shown in FIG. 2, the polarizing element (layer) 21 may be in contact with the light transparent base material 2. In a preferred embodiment of the present invention, an optional layer 20 is further provided on the outermost surface of the first polarizing plate 12. The optional layer 20 may be provided for protecting the outermost surface of the polarizing element (layer) 21 in the first polarizing plate 12. Specifically, a light transparent base material may be provided as the optional layer 20. Further, the optional layer 20 may be provided, for example, as a hardcoat layer, an anti-dazzling layer, or anti-fouling layer, for imparting other optical characteristics.

### Second Aspect of the Present Invention

According to the second aspect of the present invention, any antistatic layer is not provided in the first polarizing plate, and an antistatic laminate is provided in the second polarizing plate.

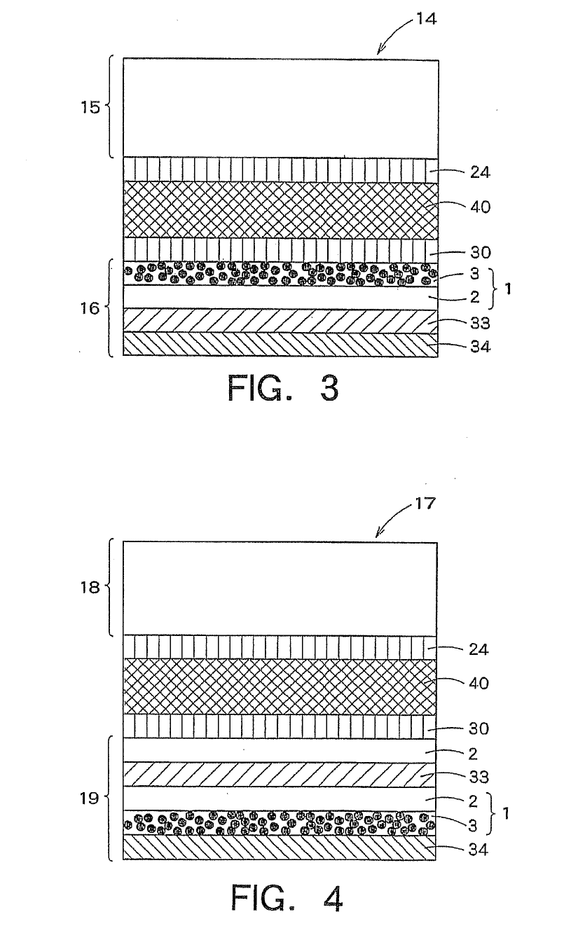

One embodiment of a light transparent display 14 according to the present invention will be described with reference to FIG. 3. FIG. 3 is a cross-sectional view of the light transparent display 14 according to the present invention. The light transparent display 14 according to the present invention has a construction comprising a light transparent display site 40 held between a first polarizing plate 15 and a second polarizing plate 16, preferably held between pressure-sensitive adhesives (layers) 24 and 30. A first polarizing plate 15 is provided on the upper surface of the light transparent display site 40 as viewed from the image display side. The first polarizing plate 15 has a construction not including any antistatic layer. The second polarizing plate 16 comprises an antistatic laminate 1 (comprising a light transparent base material 2 and an antistatic layer 3) according to the present invention and a polarizing element (layer) 33 stacked in that order. That is, in the present invention, the antistatic laminate 1 is provided on the image display side (upper surface) of the polarizing element (layer) 33. In the present invention, the polarizing element (layer) 33 may be in contact with either the antistatic layer 3 or a light transparent base material 2 in an antistatic laminate 1. Preferably, as shown in FIG. 3, the polarizing element (layer) 33 may be in contact with the light transparent base material 2 in the antistatic laminate 1. Further, in the present invention, the light transparent base material 2 may not be provided for constituting the antistatic laminate 1, and the antistatic laminate 1 may have a construction comprising the polarizing element (layer) 33 and the antistatic layer 3 in contact with each other. In a preferred embodiment of the present invention, an optional layer 34 is further provided on lowermost surface of the second polarizing plate 16 (on the lower surface of the polarizing element (layer) 33). The optional layer 34 may be provided for protecting the outermost surface of the polarizing element (layer) 33 in the second polarizing plate 16. Specifically, a light transparent base material may be used. Further, the optional layer 34 may be provided, for example, as a hardcoat layer, an anti-dazzling layer, or anti-fouling layer, for imparting other optical characteristics.

A light transparent display 17 in another embodiment of the present invention will be described with reference to FIG. 4. FIG. 4 is a cross-sectional view of a light transparent display 17 according to the present invention. The light transparent display 17 according to the present invention has a construction comprising a light transparent display site 40 held between a first polarizing plate 18 and a second polarizing plate 19, preferably held between pressure-sensitive adhesives (layers) 24 and 30. A first polarizing plate 18 is provided on the upper surface of the light transparent display site 40 as viewed from the image display side. The first polarizing plate 18 has a construction not including any antistatic layer. The second polarizing plate 19 comprises a polarizing element (layer) 33 and an antistatic laminate 1 (comprising a light transparent base material 2 and an antistatic layer 3). That is, in the present invention, the antistatic laminate 1 is provided on the non-image display side (lower surface) of the polarizing element (layer) 33. In the present invention, the polarizing element (layer) 33 may be in contact with either the antistatic layer 3 or a light transparent base material 2 in an antistatic laminate 1. Preferably, as shown in FIG. 4, the polarizing element (layer) 33 may be in contact with the light transparent base material 2 in the antistatic laminate 1. Further, in the present invention, the light transparent base material 2 may not be provided for constituting the antistatic laminate 1, and the antistatic laminate 1 may have a construction comprising the polarizing element (layer) 33 and the antistatic layer 3 in contact with each other. In a preferred embodiment of the present invention, an optional layer 34 is further provided on lowermost surface of the second polarizing plate 19 (on the lower surface of the polarizing element (layer) 33). The optional layer 34 may be provided for protecting the outermost surface of the polarizing element (layer) 33 in the second polarizing plate 19. Specifically, a light transparent base material may be used. Further, the optional layer 34 may be provided, for example, as a hardcoat layer, an anti-dazzling layer, or anti-fouling layer, for imparting other optical characteristics.

### A. First Aspect of the Present Invention

1. Antistatic Laminate (Dust Adherence Preventive Laminate)

Antistatic Layer (Conductive Layer: Dust Adherence Preventive Layer)

The antistatic layer may be formed by depositing or sputtering, for example, a conductive metal or a conductive metal oxide on the surface of a light transparent base material to form a vapor deposited film, or by coating a resin composition comprising conductive fine particles dispersed in a resin to form a coating film. In the present invention, a method is preferably adopted in which a coating film is formed by coating a resin composition comprising an antistatic agent (conductive fine particles) mixed in a curing resin.

Antistatic Agent

When the antistatic layer is formed of a vapor deposited film, antistatic agents usable herein include conductive metals or conductive metal oxides, for example, antimony doped indium tin oxide (hereinafter referred to as “ATO”) and indium tin oxide (hereinafter referred to as “ITO”). In a preferred embodiment of the present invention, the antistatic layer is preferably formed using a coating liquid containing an antistatic agent, preferably conductive fine particles. Conductive fine particles include fine particles of (transparent) metals, (transparent) metal oxides, or organic conductive materials (conductive fine particles of organic compounds). Preferred are fine particles of transparent metal oxides or organic conductive materials. Specific examples of conductive fine particles include transparent metal oxides such as antimony doped indium tin oxide (hereinafter referred to as “ATO”) and indium tin oxide (hereinafter referred to as “ITO”), or organic compound fine particles which have been surface treated with gold or nickel. Specific examples of organic conductive materials include aliphatic conjugated polyacetylene, aromatic conjugated poly-p-phenylene, heterocyclic conjugated polypyrrole, polythiophene, heteroatom-containing conjugated polyaniline, and mixed type conjugated polyphenylenevinylene. Other organic conductive materials include multi-chain-type conjugated organic conductive materials, which have a plurality of conjugated chains in the molecule thereof, and conductive composites which are polymers obtained by grafting or block copolymerizing the above conjugated polymer chain onto a saturated polymer.

The average particle diameter of the conductive fine particles is not less than 10 nm and not more than 200 nm. Preferably, the upper limit of the average particle diameter is 150 nm, and the lower limit of the average particle diameter is 50 nm.

The amount of the antistatic agent added is not less than 5% by weight and not more than 70% by weight based on the total weight of the antistatic layer. Preferably, the upper limit of the addition amount of the antistatic agent is 67% by weight, and the lower limit of the addition amount of the antistatic agent is 15% by weight. The thickness of the coating film (antistatic layer) is not less than 0.05 μm and not more than 2 μm. Preferably, the lower limit of the thickness of the coating film is 0.1 μm, and the upper limit of the thickness of the coating film is 1 μm.

Curing Resin

In the present invention, when a coating film is formed using conductive fine particles, preferably, a curing resin is used with the conductive fine particles. The curing resin is preferably transparent, and specific examples thereof include ionizing radiation curing resins, which are curable upon exposure to ultraviolet light or electron beams, for example, ultraviolet light, mixtures of ionizing radiation curing resins with solvent drying-type resins, or heat-curing resins, preferably ionizing radiation curing resins.

Dispersant

In the present invention, dispersants may be used from the viewpoint of improving the dispersibility of the antistatic agent. Dispersants usable herein include, for example, higher fatty acid esters such as polyglycerin fatty acid esters, sorbitan fatty acid esters, and sucrose fatty acid esters. Preferred are polyglycerin fatty acid esters. In particular, for the polyglycerin, in addition to straight chain polyglycerin condensed at the a position, branched polyglycerin condensed at the β position and cyclic polyglycerin may be partially contained. Preferably, the polyglycerin constituting the polyglycerin fatty acid ester has a number average degree of polymerization of about 2 to 20, more preferably about 2 to 10, from the viewpoint of realizing good dispersion state. The fatty acid is preferably a branched or straight chain saturated or unsaturated fatty acid, and examples thereof include aliphatic monocarboxylic acids, for example, caproic acid, enanthylic acid, caprylic acid, nonanoic acid, capric acid, lauric acid, myristic acid, behenic acid, palmitic acid, isostearic acid, stearic acid, oleic acid, isononanoic acid, and arachic acid. Particularly preferred polyglycerin fatty acid esters used as the higher fatty acid ester include Ajisper-PN-411 and PA-111 manufactured by Ajinomoto Fine-Techno Co., Inc. and SY-Glyster manufactured by SAKAMOTO YAKUHIN KOGYO CO., LTD.

Other dispersants usable herein include various dispersants such as sulfonic acid amide, ε-caprolactone, hydrostearic acid, polycarboxylic acid, and polyester dispersants. Specific examples thereof include Solperse 3000, Solpers 9000, Solpers 17000, Solpers 20000, Solpers 24000, and Solpers 41090 (all the above products being manufactured by ZENECA), and Disperbyk-161, Disperbyk-162, Disperbyk-163, Disperbyk-164, Disperbyk-108, Disperbyk-110, Disperbyk-111, Disperbyk-112, Disperbyk-116, Disperbyk-140, Disperbyk-170, Disperbyk-171, Disperbyk-174, Disperbyk-180, Disperbyk-182, and Disperbyk-220S (all the above products being manufactured by Bik-Chemie Japan K.K.).

The conductive fine particles may be dispersed by various dispersion methods, for example, by using pulverizers such as ultrasonic mills, bead mills, sand mills, or disk mills.

Ionizing Radiation Curing Resin

Specific examples of ionizing radiation curing resins include ionizing radiation curing resins containing an acrylate-type functional group, for example, oiligomers or prepolymers and reactive diluents of (meth)acrylate of polyfunctional compounds such as relatively low-molecular weight polyester resins, polyether resins, acrylic resins, epoxy resins, urethane resins, alkyd resins, spiroacetal resins, polybutadiene resins, polythiol polyene resins, and polyhydric alcohols. Specific examples thereof include monofunctional monomers such as ethyl (meth)acrylate, ethyl hexyl (meth)acrylate, styrene, methylstyrene, and N-vinylpyrrolidone, and polyfunctional monomers, for example, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

When the ionizing radiation curing resin is used as the ultraviolet curing resin, the use of a photopolymerization initiator is preferred. Specific examples of photopolymerization initiators include acetophenones, benzophenones, Michler's benzoyl benzoate, α-amyloxime esters, tetramethylthiuram monosulfide, and thioxanthones. Mixing of a photosensitizer in the ionizing radiation curing resin is preferred, and specific examples thereof include n-butylamine, triethylamine, and poly-n-butylphosphine.

Solvent Drying-Type Resin

Thermoplastic resins may be mainly used as the solvent drying-type resin which may be mixed into the ionizing radiation curing resin. Commonly exemplified thermoplastic resins may be used as the thermoplastic resin. The occurrence of coating film defects of the coated face can be effectively prevented by adding the solvent drying-type resin.

In a preferred embodiment of the present invention, when the material for the base material is a cellulosic resin such as TAC, specific examples of thermoplastic resins include cellulosic resins, for example, nitrocellulose, acetylcellulose, cellulose acetate propionate, and ethylhydroxyethylcellulose. The use of the cellulosic resin can improve the adhesion between the base material and the antistatic layer, and transparency.

Heat Curing Resin

Specific examples of heat curable resins include phenol resins, urea resins, diallyl phthalate resins, melamine resins, guanamine resins, unsaturated polyester resins, polyurethane resins, epoxy resins, amino alkyd resins, melanine-urea co-condensed resins, silicone resins, and polysiloxane resins. When the heat curing resin is used, if necessary, for example, curing agents such as crosslinking agents and polymerization initiators, polymerization promoters, solvents, and viscosity modifiers may be further added.

In a preferred embodiment of the present invention, among the above resins, ionizing radiation curing resins are preferred. Particularly preferred are ultraviolet curing resins. Further, in a preferred embodiment of the present invention, the mixing weight ratio between the antistatic agent and the curing resin is 90:10 to 10:90, preferably 70:30 to 30:70, more preferably 60:40 to 40:60. In mixing the antistatic agent with the curing resin, organic solvents, particularly volatile organic solvents, are used, and examples thereof include toluene and cyclohexanone.

In a more preferred embodiment, when the organic solvent is a solvent which does not permeate the light transparent base material, for example, toluene, the mixing weight ratio between the antistatic agent and the curing resin is 70:30 to 60:40, preferably 75:25 to 50:50, more preferably 65:35 to 60:40. Further, in a more preferred embodiment of the present invention, when the organic solvent is a solvent which penetrates the light transparent base material, for example, cyclohexanone, the mixing weight ratio between the antistatic agent and the curing resin is 10:90 to 90:10, preferably 20:80, more preferably 15:85.

In a preferred embodiment of the present invention, the surface resistivity of the surface (antistatic layer) of the antistatic laminate is not less than 10⁴Ω/□ and not more than 10¹²Ω/□. The mixing polymerization ratio between the antistatic agent and the curing resin is preferably selected so that this surface resistivity is provided. The surface resistivity of the outermost surface on the image display side of the polarizing plate using the antistatic laminate according to the present invention is also in the above-defined range.

In a preferred embodiment of the present invention, the strength of the antistatic layer after the saponification of the antistatic layer is substantially the same as that before the treatment of the antistatic layer. Preferably, for example, when the saponified antistatic layer is lightly rubbed by a nail, any scratch is not observed in the antistatic layer.

In the saponification, an antistatic laminate according to the present invention is immersed in an aqueous KOH solution to treat the surface of the antistatic laminate (for example, to introduce OH group). In the present invention, the evaluation by the saponification is carried out by immersing the antistatic laminate according to the present invention in KOH (concentration 2 mol/L) of 40° C. for 5 min, then lightly rubbing the surface of the antistatic layer by a nail and visually inspecting the antistatic layer for “scratch” to determine the strength.

Light Transparent Base Material

Preferably, the light transparent base material is transparent, smooth, and heat resistant and, at the same time, has excellent mechanical strength. Specific examples of materials for the light transparent base material include thermoplastic resins such as polyesters, cellulose triacetate, cellulose diacetate, cellulose acetate butyrate, polyesters, polyamides, polyimides, polyether sulfone, polysulfone, polypropylene, polymethylpentene, polyvinyl chloride, polyvinyl acetal, polyether ketone, polymethyl methacrylate, polycarbonate, or polyurethane. Preferred are polyesters and cellulose triacetate. In the present invention, phase difference films may also be used as the light transparent base material.

In the present invention, these thermoplastic resins are used as thin and highly flexible films. In applications where hardness is required, plates of these thermoplastic resins or glass plates may also be used.

The thickness of the light transparent base material is not less than 20 μm and not more than 300 μm. Preferably, the upper limit of the thickness of the light transparent base material is not more than 200 μm, and the lower limit of the thickness of the light transparent base material is not less than 30 μm. When the light transparent base material is in a plate form, the thickness may exceed the above-defined range. In forming an anti-dazzling layer on the base material, from the viewpoint of improving the adhesion, the base material may be previously subjected to physical treatment such as corona discharge treatment or oxidation treatment, or may be coated with material called an anchoring agent or a primer.

Antistatic Layer Formation

In forming a coating film as an antistatic layer, a coating liquid comprising an antistatic agent (conductive fine particles) mixed and dispersed in a curing resin is coated onto the surface of the light transparent base material by a coating method such as roll coating, Mayer bar coating, gravure coating, or die coating. After coating, drying and ultraviolet curing are carried out. The ionizing radiation curing resin is cured by electron beam or ultraviolet light irradiation. In the case of electron beam curing, for example, electron beams having an energy of 100 KeV to 300 KeV is used. On the other hand, in the case of ultraviolet curing, for example, ultraviolet light emitted, for example, from ultrahigh pressure mercury lamps, high pressure mercury lamps, low pressure mercury lamps, carbon arc lamps, xenon arc lamps, or metal halide lamps may be used.

2. Polarizing Plate

The polarizing plate has a basic construction of a laminate comprising a polarizing element held between light transparent base materials. For example, a polyvinyl alcohol film, a polyvinylformal film, a polyvinylacetal film, or an ethylene-vinyl acetate copolymer saponified film, which has been dyed with iodine or a dye and stretched, may be used as the polarizing element. Preferred are polyvinyl alcohol films. The light transparent base material for holding the polarizing element may be as described above. Triacetylcellulose films are preferred, and nonstretched triacetylcellulose films are more preferred. The polarizing plate may be formed by monoaxially stretching iodine-containing PVA to prepare a polarizing element and laminating the polarizing element between two saponified TACs.

First Polarizing Plate/Second Polarizing Plate

The first polarizing plate according to the present invention is provided on the image display surface of the light transparent display site. The antistatic laminate according to the present invention is provided beneath or below the polarizing element (layer) in the first polarizing plate. Alternatively, a luminescent element (layer) may be provided on the underside of the antistatic laminate. The second polarizing plate according to the present invention is provided in a light transparent display site on its non-image display surface. The second polarizing plate according to the present invention may be the same as the first polarizing plate, except that the antistatic laminate is not provided.

Optional Layer

An optional layer may be provided on the outermost surface of the first polarizing plate according to the present invention. Specifically, a light transparent base material may be provided. Further, from the viewpoint of imparting other optical characteristics, for example, a hardcoat layer, an anti-dazzling layer, and an anti-fouling layer may be formed as the optional layer.

Hardcoat Layer

The “hardcoat layer” refers to a layer that has a hardness of “H” or higher as determined by a pencil hardness test specified in JIS 5600-5-4 (1999). The thickness (in a cured state) of the hardcoat layer is preferably in the range of 0.1 to 100 μm, preferably in the range of 0.8 to 20 μm. The hardcoat layer is formed of a resin and an optional component.

1) Resin

The resin is preferably transparent, and three types of resins curable upon exposure to ultraviolet light or electron beams, that is, ionizing radiation curing resins, mixtures of ionizing radiation curing resins with solvent drying-type resins, and heat curing resins, may be mentioned as specific examples thereof. Preferred are ionizing radiation curing resins.

Specific examples of ionizing radiation curing resins include ionizing radiation curing resins containing an acrylate-type functional group, for example, oiligomers or prepolymers and reactive diluents of, for example, (meth)acrylate of polyfunctional compounds such as relatively low-molecular weight polyester resins, polyether resins, acrylic resins, epoxy resins, urethane resins, alkyd resins, spiroacetal resins, polybutadiene resins, polythiol polyene resins, and polyhydric alcohols. Specific examples thereof include monofunctional monomers such as ethyl (meth)acrylate, ethyl hexyl (meth)acrylate, styrene, methylstyrene, and N-vinylpyrrolidone, and polyfunctional monomers, for example, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

When the ionizing radiation curing resin is used as the ultraviolet curing resin, the use of a photopolymerization initiator is preferred. Specific examples of photopolymerization initiators include acetophenones, benzophenones, Michler's benzoyl benzoate, a-amyloxime esters, tetramethylthiuram monosulfide, and thioxanthones. Mixing of a photosensitizer in the ionizing radiation curing resin is preferred, and specific examples thereof include n-butylamine, triethylamine, and poly-n-butylphosphine.

Thermoplastic resins may be mainly used as the solvent drying-type resin which may be mixed into the ionizing radiation curing resin. Commonly exemplified thermoplastic resins may be used as the thermoplastic resin. The occurrence of coating film defects of the coated face can be effectively prevented by adding the solvent drying-type resin. In a preferred embodiment of the present invention, when the material for the transparent base material is a cellulosic resin such as TAC, specific examples of preferred thermoplastic resins include cellulosic resins, for example, nitrocellulose, acetylcellulose, cellulose acetate propionate, and ethylhydroxyethylcellulose.

Specific examples of heat curable resins include phenol resins, urea resins, diallyl phthalate resins, melanine resins, guanamine resins, unsaturated polyester resins, polyurethane resins, epoxy resins, amino alkyd resins, melamine-urea co-condensed resins, silicone resins, and polysiloxane resins. When the heat curing resin is used, if necessary, for example, curing agents such as crosslinking agents and polymerization initiators, polymerization promoters, solvents, and viscosity modifiers may be further added.

Anti-Dazzling Layer

The anti-dazzling layer may be formed of a resin and an anti-dazzling layer, and the resin may be the same as those described above in connection with the hardcoat layer.

In a preferred embodiment of the present invention, the anti-dazzling layer simultaneously satisfies all the following formulae:

30≦Sm≦600,

0.05≦Rz≦1.60,

0.1≦θa≦2.5, and

0.3≦R≦15

wherein R represents the average particle diameter of fine particles, μm; Rz represents the ten-point mean roughness of concaves and convexes in the anti-dazzling layer, μm; Sm represents concave-convex average spacing in the anti-dazzling layer, μm; and θa represents the average inclination angle of the concave-convex part.

In another preferred embodiment of the present invention, the following requirement is satisfied: Δn=|n1−n2|<0.1 wherein n1 represents the refractive index of the fine particles; and n2 represents the refractive index of the transparent resin composition, and, at the same time, the haze value within the anti-dazzling layer is not more than 55%.

Anti-Dazzling Agent

Fine particles may be mentioned as the anti-dazzling agent. The shape may be, for example, spherical or elliptical, preferably spherical. The fine particles may be an inorganic or organic type. The fine particles should have anti-dazzling properties and are preferably transparent. Specific examples of fine particles include inorganic fine particles such as silica beads and organic fine particles such as plastic beads. Specific examples of plastic beads include styrene beads (refractive index 1.59), melamine beads (refractive index 1.57), acrylic beads (refractive index 1.49), acryl-styrene beads (refractive index 1.54), polycarbonate beads, and polyethylene beads. The amount of the fine particles added is 2 to 30 parts by weight, preferably about 10 to 25 parts by weight, based on 100 parts by weight of the transparent resin composition.

An anti-settling agent is preferably added in preparing a composition for an anti-dazzling layer, because the precipitation of resin beads can be suppressed and the resin beads can be dispersed homogeneously in the solvent. Silica beads having a particle diameter of not more than 0.5 μm, preferably about 0.1 to 0.25 μm, may be mentioned as a specific example of the anti-settling agent.

The thickness (in a cured state) of the anti-dazzling layer is preferably in the range of 0.1 to 100 μm, more preferably in the range of 0.8 to 10 μm. When the layer thickness is in the above-defined range, the function as the anti-dazzling layer can be satisfactorily developed.

Low-Refractive Index Layer

The low-refractive index layer may be formed of silica, or a magnesium fluoride-containing resin, a fluororesin as a low-refractive index resin, silica, or a magnesium fluoride-containing fluororesin. The low-refractive index layer may be formed as an about 30 nm to 1 μm-thick thin film having a refractive index of not more than 1.46, or as a thin film formed by chemical vapor deposition or physical vapor deposition of silica or magnesium fluoride. Regarding resins other than fluororesins, the same resins as used for constituting the antistatic layer may be used.

More preferably, the low-refractive index layer may be formed of a silicone-containing vinylidene fluoride copolymer. The silicone-containing vinylidene fluoride copolymer is specifically produced by copolymerization using as a starting material a monomer composition containing 30 to 90% (on a mass basis; the same shall apply hereinafter) of vinylidene fluoride and 5 to 50% of hexafluoropropylene and is a resin composition comprising 100 parts of a fluorine-containing copolymer having a fluorine content of 60 to 70% and 80 to 150 parts of an ethylenically unsaturated group-containing polymerizable compound. A low-refractive index layer having a refractive index of less than 1.60 (preferably not more than 1.46), which is a thin film having a thickness of not more than 200 nm and to which rubbing/scratch resistance has been imparted, is formed using this resin composition.

For the silicone-containing vinylidene fluoride copolymer constituting the low-refractive index layer, the contents of the components in the monomer composition are 30 to 90%, preferably 40 to 80%, particularly preferably 40 to 70%, for vinylidene fluoride, and 5 to 50%, preferably 10 to 50%, particularly preferably 15 to 45%, for hexafluoropropylene. This monomer composition may further comprise 0 to 40%, preferably 0 to 35%, particularly preferably 10 to 30%, of tetrafluoroethylene.

The monomer composition may further contain other comonomer component(s) so far as the purpose of use and effect of the silicone-containing vinylidene fluoride copolymer are not scarified. Other comonomer component(s) may be contained in an amount of, for example, not more than 20%, preferably not more than 10%. Specific examples of other comonomer components include fluorine atom-containing polymerizable monomers such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and a-trifluoromethacrylic acid.

The fluorine-containing copolymer produced from the above monomer composition should have a fluorine content of 60 to 70%, preferably 62 to 70%, particularly preferably 64 to 68%. When the fluorine content is in the above-defined specific range, the fluorine-containing polymer has good solubility in the solvent. The presence of this fluorine-containing polymer as a component is very suitable, because a thin film having excellent adhesion to various base materials, having high transparency and low-refractive index and, at the same time, having satisfactorily good mechanical strength can be formed and, thus, mechanical properties such as scratch resistance of the thin film formed surface are on a satisfactorily high level.

The fluorine-containing copolymer preferably has an average molecular weight of 5,000 to 200,000, particularly preferably 10,000 to 100,000, as determined using polystyrene as a standard substance. When the fluorine-containing copolymer having a molecular weight in the above-defined range is used, the resultant fluororesin composition has a suitable viscosity. Accordingly, a fluororesin composition having suitable coatability can be reliably produced. The refractive index of the fluorine-containing copolymer per se is preferably not more than 1.45, more preferably not more than 1.42, still more preferably not more than 1.40. When a fluorine-containing copolymer having a refractive index of more than 1.45 is used, in some cases, a thin film formed using the resultant fluorine-type coating material has a low level of antireflection effect.

The low-refractive index layer may be formed of a thin film of SiO₂ and may be one formed, for example, by vapor deposition, sputtering, or plasma CVD, or by a method in which an SiO₂ gel film is formed from a sol liquid containing an SiO₂ sol. The low-refractive index layer may be formed of, in addition to SiO₂, an MgF₂ thin film or other materials. The use of an SiO₂ thin film is preferred because the adhesion to a layer underlying the thin film is high. When plasma CVD is used among the above methods, the plasma CVD is preferably carried out under such conditions that an organosiloxane is used as a starting gas and any other inorganic vapor deposition source is not used. In this case, preferably, the material to be vapor deposited is maintained at the lowest possible temperature.

In a preferred embodiment of the present invention, the utilization of “void-containing fine particles” is preferred. The “void-containing fine particles” can lower the refractive index of the low-refractive index layer while maintaining the layer strength. The term “void-containing fine particles” as used herein refers to fine particles that form a structure comprising fine particles the interior of which is filled with gas, and/or a gas-containing porous structure and in which, as compared with the refractive index inherent in the fine particles, the refractive index lowers in inverse proportion to the content of the gas in the fine particles. Further, in the present invention, fine particles, which can form, in at least a part of the interior and/or surface thereof, a nanoporous structure depending upon the form, structure, coagulated state of the fine particles and the dispersed state of the fine particles within the coating film, also fall within the scope of the present invention.

Specific examples of preferred void-containing inorganic fine particles include silica fine particles prepared by a technique disclosed in Japanese Patent Laid-Open No. 233611/2001. The void-containing silica fine particles can easily be produced and as such has high hardness. Accordingly, when the void-containing inorganic fine particles are mixed with a binder for use of the mixture in the formation of the low-refractive index layer, the strength of the formed layer is improved and, further, the refractive index can be regulated in the range of about 1.20 to 1.45. In particular, specific examples of preferred void-containing organic fine particles include hollow polymer fine particles produced by a technique disclosed in Japanese Patent Laid-Open No. 80503/2002.

In addition to the above silica fine particles, sustained release materials, which are produced for increasing the specific surface area, for adsorbing various chemical substances in a packing column and the porous part of the surface, porous fine particles for use in catalyst fixation, or hollow fine particle dispersion or aggregate for incorporation in a heat insulating material or a low-permittivity material may be mentioned as fine particles that can form a nanoporous structure in at least a part of the interior and/or surface of the coating film. Specific examples of such fine particles usable herein include commercially available products, specifically porous silica fine particle aggregates selected from Nipsil and Nipgel (tradenames, manufactured by Nippon Silica Industrial Co., Ltd.) and colloidal silica UP Series having a structure comprising silica fine particles connected to each other in a chain form (tradename, manufactured by Nissan Chemical Industries Ltd.), which have particles diameters falling within a preferred range in the present invention.

The average particle diameter of the “void-containing fine particles” is not less than 5 nm and not more than 300 nm. Preferably, the lower limit of the average particle diameter is 8 nm, and the upper limit of the average particle diameter is 100 nm. More preferably, the lower limit of the average particle diameter is 10 nm, and the upper limit of the average particle diameter is 80 nm. When the average particle diameter of the fine particles is in the above-defined range, excellent transparency can be imparted to the low-refractive index layer.

Anti-Fouling Layer

The anti-fouling layer can further improve the antifouling properties and rubbing/scratch resistance of the antireflective laminate. Specific examples of agents usable for the anti-fouling layer include fluorocompounds and/or silicon compounds, which have low compatibility with a composition of an ionizing radiation curing resin having a fluorine atom in its molecule and thus cannot be added to the low-refractive index layer without difficulties, and fluorocompounds and/or silicon compounds, which are compatible with a composition of an ionizing radiation curing resin having a fluorine atom in its molecule, and the fine particles.

3. Light Transparent Display

The light transparent display according to the present invention comprises a light transparent display site and two polarizing plates sandwiching the light transparent display site therebetween. The polarizing plates are preferably those according to the present invention. More preferably, the polarizing plate on the image viewing side is the first polarizing plate according to the present invention, and the polarizing plate on the image non-viewing side is the second polarizing plate according to the present invention. The light transparent display site is an image forming site, and any display method may be used. Examples thereof include liquid crystal display, electroluminescent display, and light emitting diode display.

4. Image Display Device

According to a further embodiment of the present invention, there is provided an image display device. This image display device comprises a light transparent display and a light source device for applying light to the light transparent display from the backside thereof. The light transparent display is the above light transparent display according to the present invention.

5. Use

The anti-dazzling laminate and antireflective laminate according to the present invention are used as a material for constituting a polarizing plate. The image display device is utilized in transmission display devices, particularly displays for televisions, computers, and word processors. More particularly, the image display device is used in the surface of high-definition image displays such as liquid crystal panels. More specific applications include display products such as liquid crystal televisions, computers, word processors, portable telephones (cellular phones), and car navigations.

### B. Second Aspect of the Present Invention

According to the second aspect of the present invention, there is provided a light transparent display comprising a light transparent display site held between a first polarizing plate and a second polarizing plate. In the present invention, the first polarizing plate does not comprise any antistatic layer, and the second polarizing plate comprises an antistatic laminate according to the present invention. Accordingly, the first polarizing plate, the second polarizing plate, and the antistatic laminate may be as described in the first aspect of the present invention.

In another embodiment (FIG. 4) in the second aspect of the present invention, the second polarizing plate comprises an antistatic laminate and a polarizing element stacked in that order, or comprises a polarizing element and an antistatic laminate stacked in that order. In this embodiment, preferably, the second polarizing plate comprises an antistatic laminate according to the present invention. However, an antistatic laminate different from the antistatic laminate according to the present invention may be used so far as the effect of the present invention can be attained. Further, in this embodiment, the optional layer comprises a light transparent base material as an indispensable layer and optionally a hardcoat layer, an anti-dazzling layer, a low-refractive index layer, an anti-fouling layer and the like stacked thereon.

### EXAMPLES

The following Examples and Comparative Examples further illustrate the present invention but are not intended to limit it.

Basic Composition for Antistatic Layer Formation

A composition for antistatic layer formation was prepared by mixing according to the following formulation.

Basic Composition 1

| | |
|---|---|
| Antistatic agent (ATO) | 30 parts by mass |
| (T-1 ATO-type ultrafine particles; | |
| tradename, manufactured by JEMCO Inc., | |
| average primary particle diameter | |
| 20 nm) | |
| Pentaerythritol triacrylate | 10 parts by mass |
| (PET30; tradename, manufactured by | |
| Nippon Kayaku Co., Ltd.) | |
| Toluene | 60 parts by mass |
| Dispersant (Ajisper PN-411; tradename, | 2.5 parts by mass |
| manufactured by Ajinomoto Fine-Techno | |
| Co., Inc.) | |

Basic Composition 2

Basic composition 2 was prepared in the same manner as in basic composition 1, except that cyclohexanone was used instead of toluene.

Basic Composition 3

A thiophene-type conductive polymer coating liquid (EL Coat-TA LP2010, manufactured by Idemitsu Technofine Co., Ltd.) was used.

Basic Composition 4

A thiophene-type conductive polymer coating liquid (EL Coat UVH515 (2), manufactured by Idemitsu Technofine Co., Ltd.) was used.

Basic Composition 5

| | |
|---|---|
| Antistatic agent (ATO) | 5 parts by mass |
| (ASHD300S manufactured by | |
| The Inctec Inc.) | |
| Cyclohexanone | 22 parts by mass |
| Polymerization initiator | 0.2 part by mass |
| (Irgacure 184, manufactured by | |
| Ciba Specialty Chemicals, K.K.) | |

### Example 1

A transparent base material film (80 μm-thick triacetylcellulose resin film (TF80UL, manufactured by Fuji Photo Film Co., Ltd.)) was provided. The following coating liquid for transparent antistatic layer formation was coated by a wire wound-type coating rod onto one side of the film. The assembly was held in a hot oven of 70° C. for 30 sec to evaporate the solvent in the coating film. Thereafter, ultraviolet light was applied at an integrated light quantity of 98 mj to cure the coating film and to form a transparent antistatic layer at a coverage of 0.7 g/cm² on a dry basis. Thus, an antistatic laminate was prepared.

Preparation of Coating Liquid for Transparent Antistatic Layer Formation

A coating liquid for transparent antistatic layer formation was prepared according to the following formulation.

| | |
|---|---|
| Basic Composition 1 | 100 parts by mass |
| Initiator | 5 parts by mass |
| (Irgacure 907; tradename, | based on resin component |
| manufactured by Ciba Specialty | |
| Chemicals, K.K.) | |
| Toluene | 438 parts by mass |

### Example 2

An antistatic laminate was prepared in the same manner as in Example 1, except that a coating liquid for transparent antistatic layer formation was prepared according to the following formulation.

| | |
|---|---|
| Basic Composition 1 | 100 parts by mass |
| Pentaerythritol triacrylate | 3.5 parts by mass |
| Initiator | 5 parts by mass |
| (Irgacure 907; tradename, | based on resin component |
| manufactured by Ciba Specialty | |
| Chemicals, K.K.) | |
| Toluene | 460 parts by mass |

### Example 3

An antistatic laminate was prepared in the same manner as in Example 1, except that a coating liquid for transparent antistatic layer formation was prepared according to the following formulation.

| | |
|---|---|
| Basic Composition 1 | 100 parts by mass |
| Pentaerythritol triacrylate | 5.2 parts by mass |
| Initiator | 5 parts by mass |
| (Irgacure 907; tradename, | based on resin component |
| manufactured by Ciba Specialty | |
| Chemicals, K.K.) | |
| Toluene | 485 parts by mass |

### Example 4

An antistatic laminate was prepared in the same manner as in Example 1, except that a coating liquid for transparent antistatic layer formation was prepared according to the following formulation.

| | |
|---|---|
| Basic Composition 2 | 100 parts by mass |
| Dipentaerythritol hexaacrylate | 95 parts by mass |
| (DPHA; tradename, manufactured | |
| by Nippon Kayaku Co., Ltd.) | |
| Initiator | 5 parts by mass |
| (Irgacure 907; tradename, | based on resin component |
| manufactured by Ciba Specialty | |
| Chemicals, K.K.) | |
| Cyclohexanone | 710 parts by mass |

### Example 5

An antistatic laminate was prepared in the same manner as in Example 1, except that a coating liquid for transparent antistatic layer formation was prepared according to the following formulation.

| | |
|---|---|
| Basic Composition 2 | 100 parts by mass |
| Dipentaerythritol hexaacrylate | 147 parts by mass |
| (DPHA; tradename, manufactured | |
| by Nippon Kayaku Co., Ltd.) | |
| Initiator | 5 parts by mass |
| (Irgacure 907; tradename, | based on resin component |
| manufactured by Ciba Specialty | |
| Chemicals, K.K.) | |
| Cyclohexanone | 700 parts by mass |

### Example 6

Basic composition 3 was coated by a wire wound-type coating rod onto the light transparent base material prepared in Example 1, and the assembly was held in a hot oven of 70° C. for one min to evaporate the solvent contained in the coating film and to heat cure the coating film. Thus, a transparent antistatic layer was formed at a coverage of 0.7 g/cm² on a dry basis to prepare an antistatic laminate.

### Example 7

Basic composition 4 was coated by a wire wound-type coating rod onto the light transparent base material prepared in Example 1, and the assembly was held in a hot oven of 60° C. for 2 min to evaporate the solvent contained in the coating film. Thereafter, ultraviolet light was applied to the coating film under nitrogen purge at an integrating light quantity of 500 mj to cure the coating film and to form a transparent antistatic layer at a coverage of 0.7 g/cm² on a dry basis. Thus, an antistatic laminate was prepared.

### Comparative Example 1

### Preparation of Composition for Hardcoat Layer

The following ingredients were mixed and dispersed according to the following formulation to prepare a composition for a hardcoat layer.

| | |
|---|---|
| Pentaerythritol triacrylate | 100 parts by mass |
| (PET30 manufactured by Nippon | |
| Kayaku Co., Ltd.) | |
| Methyl ethyl ketone | 43 parts by mass |
| Leveling agent | 2 parts by mass |
| (MCF-350-5 manufactured by | |
| Dainippon Ink and Chemicals, Inc.) | |
| Polymerization initiator | 6 parts by mass |
| (Irgacure 184 manufactured by | |
| Ciba Specialty Chemicals, K.K.) | |

Preparation

A transparent base material film (80 μm-thick triacetylcellulose resin film (TF80UL, manufactured by Fuji Photo Film Co., Ltd.)) was provided. Basic composition 5 for antistatic layer formation was coated by a wire wound-type coating rod onto one side of the film. The assembly was held in a hot oven of 70° C. for 30 sec to evaporate the solvent in the coating film. Thereafter, ultraviolet light was applied at an integrated light quantity of 98 mj to cure the coating film and to form a transparent antistatic layer at a coverage of 0.7 g/cm² on a dry basis. After antistatic layer formation, the composition for a hardcoat layer was coated. The assembly was held in an oven of 70° C. for 30 sec to evaporate the solvent contained in the coating film. Thereafter, ultraviolet light was applied to the coating film at an integrating light quantity of 46 mj to cure the coating film and to form a transparent hardcoat layer at a coverage of 15 g/cm² on a dry basis on the antistatic layer. Thus, an antistatic laminate with a hardcoat was prepared.

### Comparative Example 2

### Preparation of Composition for Anti-Dazzling Layer

A composition for an anti-dazzling layer was prepared by mixing and dispersing the following ingredients according to the following formulation.

| | |
|---|---|
| Pentaerythritol triacrylate | 70 parts by mass |
| (PET30 manufactured by Nippon | |
| Kayaku Co., Ltd.) | |
| Isocyanuric acid EO modified diacrylate | 30 parts by mass |
| (manufactured by TOAGOSEI Co., Ltd.) | |
| 3.5 μm styrene beads | 15 parts by mass |
| (manufactured by Soken Chemical | |
| Engineering Co., Ltd.) | |
| Conductive beads | 0.14 part by mass |
| (Bright 20 GNR 4.6 EH manufactured | |
| by Nippon Kagaku Kogyo Co., Ltd.) | |
| Leveling agent | 0.01 part by mass |
| (10-28 manufactured by The | |
| Inctec Inc.) | |
| Toluene | 127.5 parts by mass |
| Cyclohexanone | 54.6 parts by mass |

Preparation

A transparent base material (80 μm-thick triacetylcellulose resin film (TF80UL, manufactured by Fuji Photo Film Co., Ltd.)) was provided. Basic composition 5 for antistatic layer formation was coated by a wire wound-type coating rod onto one side of the film. The assembly was held in a hot oven of 70° C. for 30 sec to evaporate the solvent in the coating film. Thereafter, ultraviolet light was applied at an integrated light quantity of 98 mj to cure the coating film and to form a transparent antistatic layer at a coverage of 0.7 g/cm² on a dry basis. After antistatic layer formation, the coating composition for an anti-dazzling layer was coated by a wire wound-type coating rod (#12). The assembly was held in an oven of 70° C. for 30 sec to evaporate the solvent contained in the coating film. Thereafter, ultraviolet light was applied to the coating film at an integrating light quantity of 46 mj to cure the coating film and to form an anti-dazzling layer on the antistatic layer. Thus, an anti-dazzling antistatic laminate was prepared.

Preparation of Polarizing Plate

Preparation of Polarizing Element

An 80 μm-thick polyvinyl alcohol film was dyed in a 0.3% aqueous iodine solution, was then stretched by five times in an aqueous solution containing 4% boric acid and 2% potassium iodide, and was then dried at 50° C. for 4 min to prepare a polarizing element.

Preparation of Polarizing Plate

The antistatic laminates coated with an antistatic layer prepared in the Examples were immersed in a 2 mol/L aqueous KOH solution of 40° C. for 5 min for saponification. Thereafter, the treated antistatic laminates were washed with pure water and were then dried at 70° C. for 5 min. Subsequently, an adhesive formed of a 7% aqueous polyvinyl alcohol solution was coated onto the saponified antistatic laminate in its light transparent base material side, and the assembly was applied to one side of a polarizer to prepare a polarizing plate with one side-protecting film. Thereafter, another transparent base material film (80 μm-thick TAC film: TF80UL manufactured by Fuji Photo Film Co., Ltd.) was saponified as described above. The same adhesive as described above was applied to the saponified transparent base material film. The assembly was laminated onto the other side of the polarizer to prepare a polarizing plate with the antistatic laminate according to the present invention.

Evaluation Test

The antistatic laminates prepared in the Examples were evaluated by the following evaluation tests, and the results are summarized in Table 1 below.

Property Evaluation Test

1) The surface resistivity value (Ω/□) was measured with a surface resistivity measuring device (product No. Hiresta IP MCP-HT260, manufactured by Mitsubishi Chemical Corporation).

2) The total light transmittance (%) was measured with a haze meter (product No. HM-150, manufactured by Murakami Color Research Laboratory).

3) The haze value (%) was measured with a haze meter (product No. HM-150, manufactured by Murakami Color Research Laboratory).

Evaluation 1: Surface Hardness Test

The surface hardness was determined by lightly rubbing the surface of the antistatic layer in the antistatic laminate by finger cushion and nail twice and visually inspecting the antistatic layer for surface scratches. The results were evaluated according to the following criteria.

Evaluation Criteria

⊚: No scratches were observed.

◯: Upon rubbing by finger cushion, no “scratch” occurred, whereas, upon rubbing by finger nail, slight “scratch” on such a level that does not cause a technical problem, occurred.

Δ: Upon rubbing by finger cushion, no “scratch” occurred, whereas, upon rubbing by finger nail, “scratch” occurred.

x: Upon rubbing by finger cushion, “scratch” occurred.

Evaluation 2: Dust Adherence Prevention Test

A polarizing plate with TAC laminated onto only one side thereof, that is, a polarizing plate with one-side protecting film (the polarizer on the other side being exposed), was provided. Each of the antistatic laminates prepared in the Examples and Comparative Examples on its TAC side was laminated onto the polarizing plate in its polarizer side with the aid of a transparent pressure-sensitive adhesive to prepare a polarizing plate. In the Examples, on the assumption that the antistatic layer is formed on a surface below the polarizing element, the TAC surface on the antistatic layer-free side was rubbed by a polyester cloth by 20 times of reciprocation. The rubbed face was brought close to a cigarette ash, and the dust adherence prevention effect was evaluated according to the following criteria. In the Comparative Examples, on the assumption that the antistatic layer laminate is formed on a surface opposite to the Examples, that is, on a surface above the polarizing element, the hardcoat layer surface and anti-dazzling layer surface on the antistatic layer side were rubbed by a polyester cloth by 20 times of reciprocation. The rubbed face was brought close to a cigarette ash, and the dust adherence prevention effect was evaluated according to the following criteria.

Evaluation Criteria

⊚: No ash adherence occurred, that is, dust adherence prevention effect was observed.

x: A large amount of ash was adhered, that is, no dust adherence prevention effect was observed.

TABLE 1

| | | | Surface | Total light | | | |
|---|---|---|---|---|---|---|---|
| | Saponification | | resistivity, Ω/□ | transmittance, % | Haze value, % | Evaluation 1 | Evaluation 2 |
| Example 1 | Before | ◯ | 7.0 × 10⁷ | 90.9 | 2.9 | ⊚ | ⊚ |
| | After | Δ | 5.0 × 10⁶ | 91.2 | 2.5 | ⊚ | ⊚ |
| Example 2 | Before | ⊚ | 5.1 × 10⁹ | 91.0 | 2.3 | ⊚ | ⊚ |
| | After | ◯ | 8.0 × 10⁷ | 92.0 | 2.7 | ⊚ | ⊚ |
| Example 3 | Before | ⊚ | 1.5 × 10¹¹ | 90.2 | 2.0 | ⊚ | ⊚ |
| | After | ⊚ | 3.5 × 10⁹ | 91.5 | 2.1 | ⊚ | ⊚ |
| Example 4 | Before | ⊚ | 7.0 × 10⁸ | 90.1 | 2.6 | ⊚ | ⊚ |
| | After | ◯ | 5.5 × 10⁷ | 91.5 | 2.0 | ⊚ | ⊚ |
| Example 5 | Before | ⊚ | 6.0 × 10⁹ | 90.1 | 2.3 | ⊚ | ⊚ |
| | After | ⊚ | 5.0 × 10⁸ | 91.1 | 1.9 | ⊚ | ⊚ |
| Example 6 | Before | ⊚ | 1.0 × 10³ | 91.5 | 0.3 | ⊚ | ⊚ |
| | After | ⊚ | 6.6 × 10³ | 91.5 | 0.4 | ⊚ | ⊚ |
| Example 7 | Before | ⊚ | 2.3 × 10⁶ | 91.4 | 0.3 | ⊚ | ⊚ |
| | After | ⊚ | 2.5 × 10⁶ | 91.5 | 0.4 | ⊚ | ⊚ |
| Comparative | Before | ⊚ | 4.0 × 10¹² | 90.4 | 0.4 | ⊚ | ⊚ |
| Example 1 | After | ⊚ | 4.0 × 10¹² | 90.4 | 0.4 | ⊚ | ⊚ |
| Comparative | Before | ⊚ | 3.5 × 10⁸ | 90.8 | 35 | ⊚ | ⊚ |
| Example 2 | After | ⊚ | 4.0 × 10⁸ | 90.8 | 35 | ⊚ | ⊚ |

What is claimed:

1. A light transparent display comprising a light transparent display site held between a first polarizing plate and a second polarizing plate, wherein
said first polarizing plate is provided on said light transparent display site in its image display side and does not comprise any antistatic laminate,
said second polarizing plate comprises an antistatic laminate and a polarizing element,
said antistatic laminate and said polarizing element are provided in that order, or alternatively said polarizing element and said antistatic laminate are provided in that order and
said antistatic laminate comprises a light transparent base material and an antistatic layer provided on said light transparent base material,
said antistatic layer comprises polythiophene, and
said light transparent base material is a triacetylcellulose resin film.

2. The light transparent display according to claim 1, wherein said antistatic layer is located beneath or below said polarizing element in said second polarizing plate as viewed from an image display side.

3. The light transparent display according to claim 1, wherein said antistatic layer is attached to said light transparent display through an adhesive layer.

4. An image display device comprising a light transparent display and a light source device for applying light to said light transparent display from its backside, wherein said light transparent display is one according to claim 1.
